(19) United States
(12) Patent Application Publication
(10) Pub. No.: US 2014/0050497 A1
(43) Pub. Date: Feb. 20, 2014

(54) INDEPENDENT CONTROL OF PRESSURE ROLLER HEATING ELEMENTS TO PROVIDE GLOSS UNIFORMITY

(71) Applicants: Christopher A. Jensen, Rochester, NY (US); Steven M. Russel, Bloomfield, NY (US); Erwin Ruiz, Rochester, NY (US); Jeffrey N. Swing, Rochester, NY (US)

(72) Inventors: Christopher A. Jensen, Rochester, NY (US); Steven M. Russel, Bloomfield, NY (US); Erwin Ruiz, Rochester, NY (US); Jeffrey N. Swing, Rochester, NY (US)

(73) Assignee: XEROX Corporation, Norwalk, CT (US)

(21) Appl. No.: 13/586,062

(22) Filed: Aug. 15, 2012

(51) Int. Cl. G03G 15/20

(52) U.S. Cl. 399/67; 399/69

(57) ABSTRACT

Methods and systems feed sheets of media on a media path within a printer device and place marking material on the sheets of media to produce printed sheets using a marking station. The methods and systems press the sheets of media using a pressure roller to join the marking material to the sheets of media and control heating elements to heat different portions of the pressure roller differently based upon the gloss level of the printed sheets using the processor.

### BACKGROUND

Embodiments herein generally relate to printing devices that use pressure rollers to join marking material to print media and more particularly to the independent control of pressure roller heating elements to provide gloss uniformity.

Modern printing devices are subjected to excessive competing production objectives. Printing devices need to be fast, produce high quality prints, be reliable, and have a reasonable cost and operating expense. In one example, a large gloss variation across a print is unacceptable to many customers; however, control of gloss variation can involve various expensive and elaborate solutions, such as a cooling system on the prefuser transport to reduce temperature differences across the paper, convectively heating the paper post fusing, use of an additional clear toner, adjusting nip, oil rate, fuser temperature, fuser speed, and toner mass, letting customers select different gloss buckets that change nip, speed, and fuser temperature, etc. Such solutions undesirably increase the cost and complexity of the printing devices in order to increase gloss uniformity.

### SUMMARY

The embodiments herein provide gloss uniformity inboard to outboard (in the cross-process direction) on a print controlled by adjustable pressure roll temperature profile (that utilizes different temperatures and along the length of the pressure roll (in the cross process direction)) based on paper width, paper thickness, and registration distribution system (RDS) position or an inline gloss sensor feedback device.

An exemplary printer apparatus herein includes a processor, and a media path operatively connected to the processor. The media path feeds print media, such as sheets of media, within the printer apparatus in the processing direction. A marking station is operatively connected to the processor. The marking station is positioned along the media path, and places marking material on the sheets of media to produce printed sheets. A pressure roller or pressure belt (hereinafter simply referred to as a pressure roller) is positioned along the media path and presses the sheets of media to join the marking material to the sheets of media. Independently controlled heating elements are operatively connected to the processor, and the multiple heating elements are positioned adjacent the (single) pressure roller. The heating elements are positioned along the length (parallel to the axle) of the pressure roller.

The processor controls the heating elements to simultaneously produce different amounts of heat from different ones of the heating elements to heat different portions of the pressure roller differently based upon the gloss level of the printed sheets. More specifically, the processor adjusts the heating of the different portions of the pressure roller differently based upon the thickness and size of the sheets of media and the position of the sheets of media on the pressure roller.

In some embodiments, a gloss sensor is operatively connected to the processor. The gloss sensor is placed along the media path in a position that senses a gloss level of the sheets of media before the sheets of media reach the marking station. In such embodiments, the processor adjusts the heating of the different portions of the pressure roller differently based upon the gloss level of the sheets of media detected by the gloss sensor.

An exemplary method herein feeds sheets of media on the media path within the printer device and places marking material on the sheets of media to produce printed sheets using the marking station. This exemplary method presses the sheets of media using a pressure roller to join the marking material to the sheets of media and controls the heating elements to heat different portions of the pressure roller differently based upon the gloss level of the printed sheets using the processor.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a graph illustrating operations performed by embodiments herein;

FIG. 2 is a block diagram illustrating features of embodiments herein;

FIG. 3 is a block diagram illustrating features of embodiments herein;

FIG. 4 is a flow diagram illustrating features of embodiments herein;

FIG. 5 is a side-view schematic diagram of a device according to embodiments herein;

FIG. 6 is a perspective-view schematic diagram of a device according to embodiments herein;

FIG. 7 is a perspective-view schematic diagram of a device according to embodiments herein;

FIG. 8 is a side-view schematic diagram of a device according to embodiments herein; and

FIG. 9 is a side-view schematic diagram of a device according to embodiments herein.

### DETAILED DESCRIPTION

One element of modern printing devices is a pressure roller (described in greater detail below) that joins marking material (toner, ink, etc.) to the print media (paper, transparencies, metal, plastic, etc.; in sheet form or as a continuous web of material). In electrostatic printers, toner power is fused to the print media using heat and pressure produced by a pressure roller and an opposing roller in a fuser device. In solid ink printers, a pressure roller and opposing roller similarly press and heat the media to spread out isolated droplets of ink on the print media to make a continuous layer, so that spaces between adjacent drops are filled and image solids become uniform. However, conventional uniform heating of such pressure rollers can produce gloss irregularities.

The embodiments herein regulate gloss uniformity across the print by varying and controlling the pressure roll temperature profile. Different temperature profiles are based on the width and weight of paper being run and the RDS (Registration Distribution System) position, and this can, in some embodiments, be combined with an inline measurement system to automatically control the gloss.

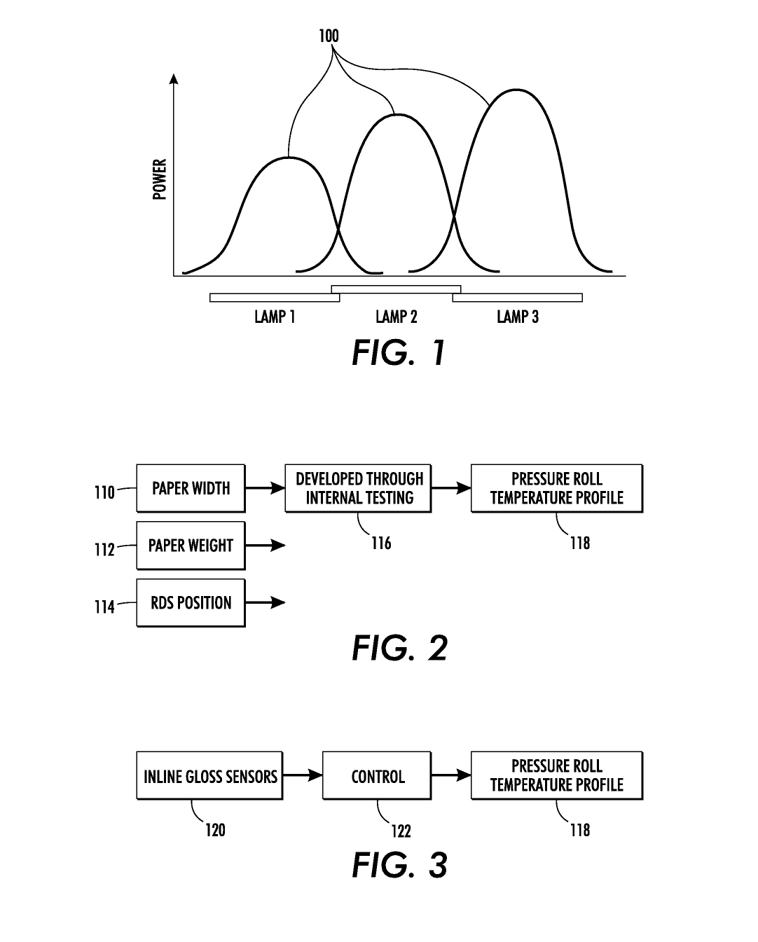

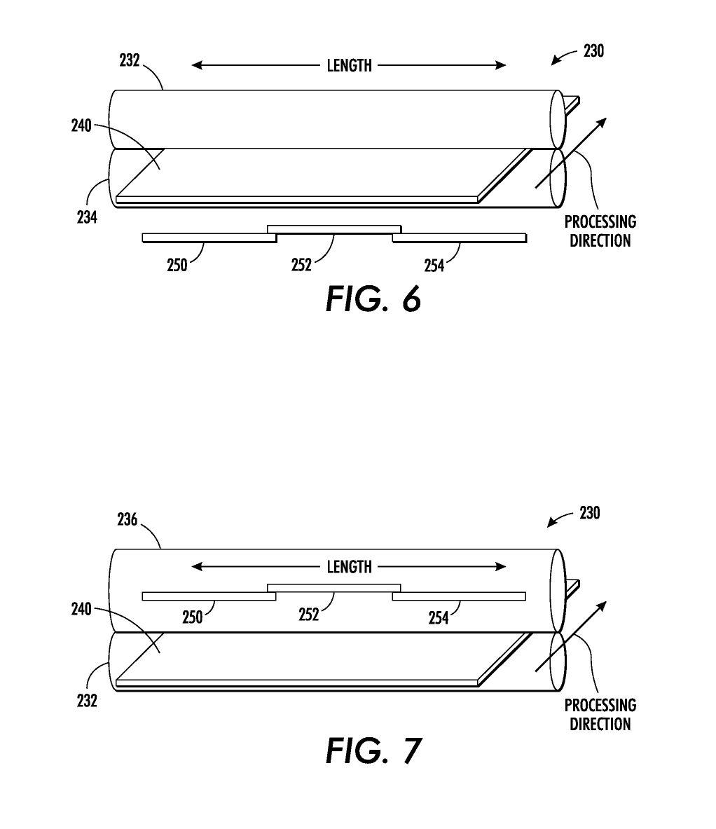

By controlling and adjusting the pressure roll temperature irregularly in the cross-process direction, prints with a uniform inboard to outboard gloss can be consistently achieved. Controlling the pressure roll temperature profile can, for example, be accomplished by putting multiple independently controlled lamps within the pressure roll and adjusting the bias irregularly between the lamps. For example, as shown in FIG. 1, three lamps (1, 2, and 3) or other heating elements (shown as items 250, 252, 254, in FIG. 6, discussed below) are supplied with different power levels 100 to unevenly heat the length of the pressure roller to control and adjust the temperature inboard-center-outboard (IB-Center-OB) to be irregular. Therefore, for example, one end or both ends of the pressure roller can be heated to a higher or lower temperature from the other portions of the pressure roller. While the examples herein illustrate 3 heating elements, those ordinarily skilled in the art would understand that any number of heating elements could be utilized such as 4, 7, 10, 20, etc., depending upon in the specific implementation, the granularity to which gloss control is desired, the length of the pressure roller, the size of the heating elements, etc.

As shown in FIG. 2, with methods and systems herein pressure roll cross-process temperature irregularity profiles 118 are chosen based on the paper width 110, paper thickness 112, and RDS position 114 (based on testing and modeling of these parameters 116). As shown in FIG. 3, pressure roll cross-process temperature irregularity profiles 118 are alternatively or additionally chosen based on an inline gloss measurement system 120 that is interpreted by a control element 122. Thus, the systems and methods herein adjust the pressure roll cross-process temperature irregularity profile 118 automatically to achieve uniform prints.

This eliminates large inboard-to-outboard gloss variation by compensating for the uniqueness of each printing device and the uniqueness that each print job presents. For example an RDS system can move the fuser assembly in the cross-process direction thus changing the relative position of prints on the pressure roll. The embodiments herein compensate for the gloss level change that may occur because the RDS is in different positions.

Further, the printing device may be irregularly creating a gloss condition because of damage or unique features within the photoreceptor belt, within the transfer stations that deposit toner on the photoreceptor belt, within individual inkjets which may be operating differently in the cross-process direction, etc., that may consistently change the gloss level in the cross-process direction. In other words, certain elements within the printing engine may be worn, contain manufacturing defects, or otherwise not operating consistently in the cross-process direction, creating loss variations in the cross-process direction. Again, by irregularly heating the pressure roller in the cross-process direction, the systems and methods herein compensate for the uniqueness of the printing device that may be causing gloss irregularities in the cross-process direction.

Additional factors which may cause gloss irregularities in the cross-process direction included defects in the print media itself, a unique consistent pattern of gloss demands required by the print job, etc. Again, the systems and methods herein compensate for such unusual gloss irregularities by adjusting the gloss levels using different pressure roller temperatures in the cross-process direction.

Further, systems and methods herein do not need to change critical fusing parameters in order to adjust gloss levels. Toner fix is relatively robust to changes in pressure roll temperature as compared to fuser roll temperature.

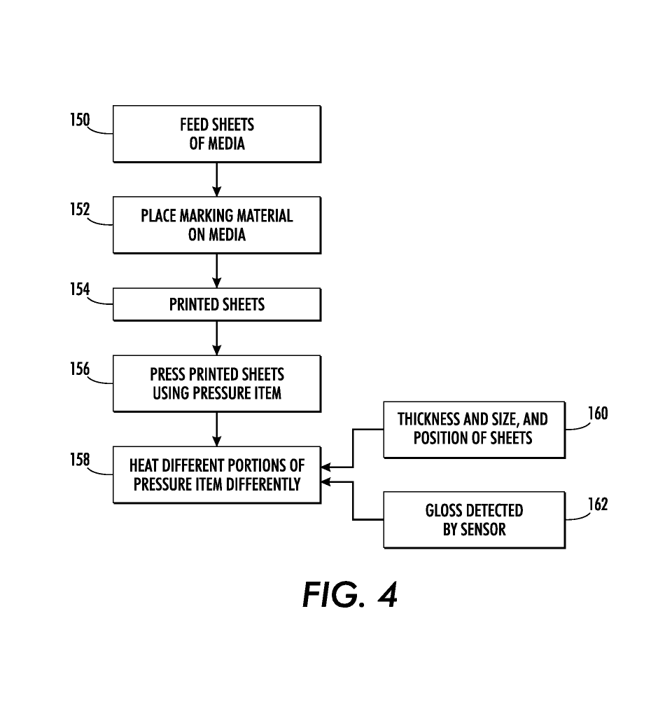

FIG. 4 is flowchart illustrating an exemplary method herein. In item 150, this method feeds sheets of media on a media path within a printer device. In item 152, this exemplary method places marking material on the sheets of media to produce printed sheets 154 using a marking station of the printer device. This exemplary method then presses the sheets of media using a pressure roller or pressure belt (which is sometimes referred to herein simply as a pressure roller or pressure item) to join the marking material to the sheets of media in item 156. In item 158, this method controls the heating elements to heat different portions of the pressure roller differently based upon the gloss level of the printed sheets using the processor (again, determined based on the thickness and size of the media, and the position of the media on the pressure roller 160; and/or based on the amount of gloss detected by one or more sensors 162).

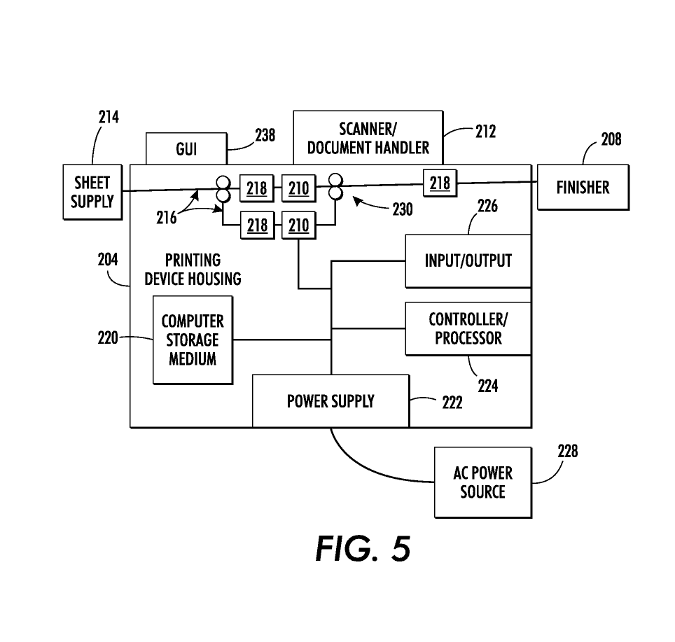

FIG. 5 illustrates a computerized printing device 204, which can be used with embodiments herein and can comprise, for example, a printer, copier, multi-function machine, multi-function device (MFD), etc. The device 204 includes a controller/processor 224 and a communications port (input/output) 226 operatively connected to the processor 224 and to a computerized network external to the computerized device 200. Also, the device 204 can include at least one accessory functional component, such as a graphic user interface assembly 238 that also operate on the power supplied from the external power source 228 (through the power supply 222).

The printing device 204 includes at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can fold, staple, sort, etc., the various printed sheets. Also, the printing device 204 can include at least one accessory functional component (such as a scanner/document handler 212, etc.) that also operate on the power supplied from the external power source 228 (through the power supply 222).

The input/output device 226 is used for communications to and from the device 204. The processor 224 controls the various actions of the device 204. A non-transitory computer storage medium device 220 (which can be optical, magnetic, capacitor based, etc.) is readable by the processor 224 and stores instructions that the processor 224 executes to allow the device 204 to perform its various functions, such as those described herein. Thus, as shown in FIG. 5, a body housing 204 has one or more functional components that operate on power supplied from the alternating current (AC) 228 by the power supply 222. The power supply 222 can comprise a power storage element (e.g., a battery) and connects to an external alternating current power source 228 and converts the external power into the type of power needed by the various components.

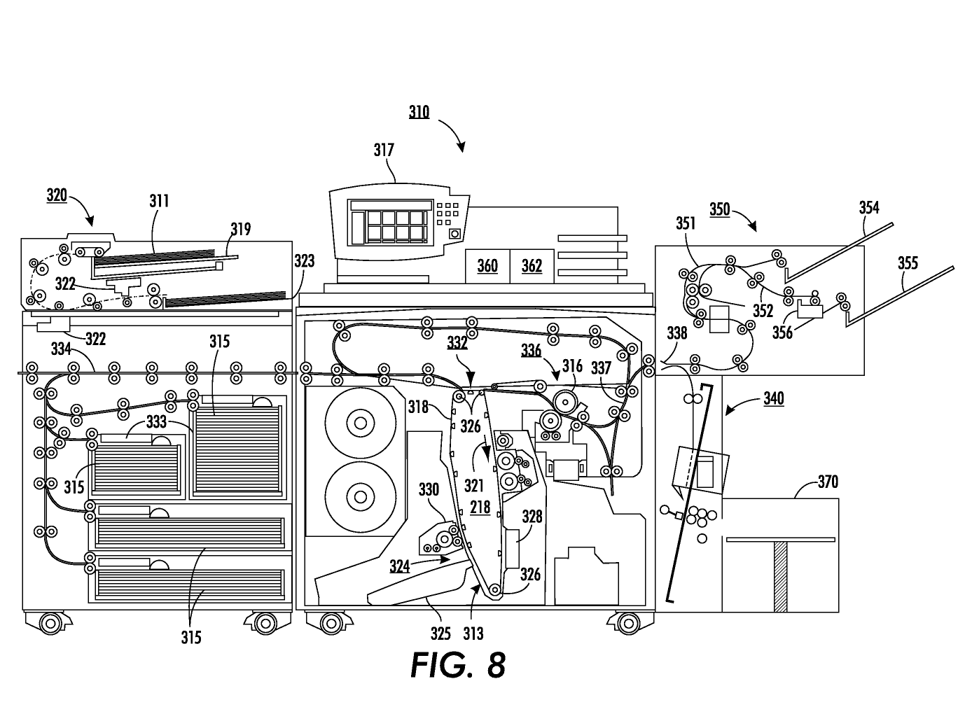

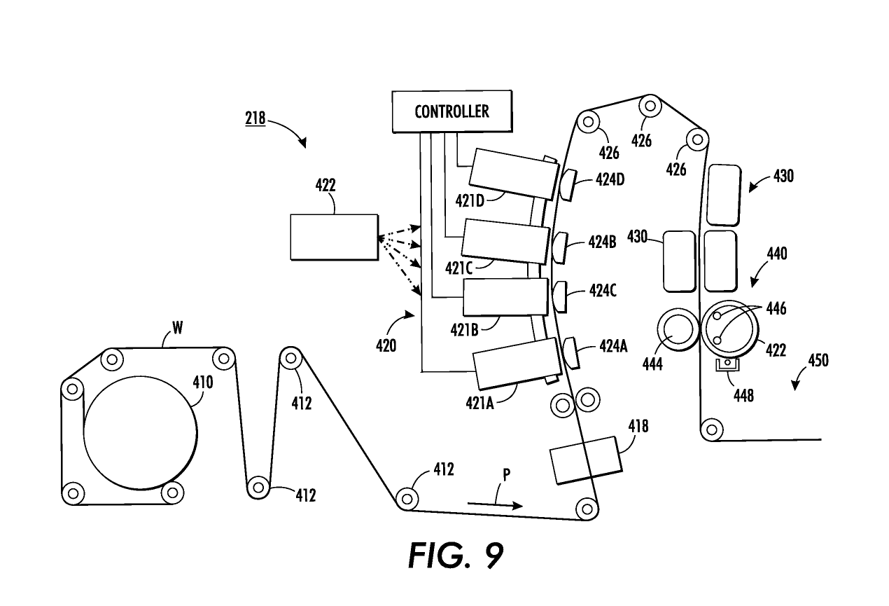

Thus, as shown at least one marking station 210 is operatively connected to the processor 224. The marking station(s) 210 are positioned along the media path 216, and place marking material on the sheets of media to produce printed sheets. One of the printed sheets is shown as item 240 in FIG. 6. Opposing rollers or a belt/roller combination 230 (which can be any form of rollers, such as the fuser device 316, shown in FIG. 8 or the spreader 440, shown in FIG. 9, below) are positioned along the media path.

As shown in greater detail in FIG. 6, the opposing rollers include a pressure roller 234 and an opposing roller 232 that form a nip where the rollers contact one another. Heat and pressure at the nip permanently attach (join, bond, fuse, etc.) the marking material to the sheet of media 240. Thus, the pressure roller 234 presses and heats the sheets of media 240 to join the marking material to the sheets of media 240. FIG. 7 illustrates a similar structure, but having a pressure belt 236 in place of the pressure roller 234.

Independently controlled heating elements 250, 252, 254 are operatively connected to the processor 224. The heating elements 250, 252, 254 can comprise any form of heating device including contact heating elements, radiant heating elements, conductive heating elements, convective heating elements, etc. As shown, the multiple heating elements 250, 252, 254 are positioned adjacent the (single) pressure roller/belt 234, 236 and along the length (parallel to the axle) of the pressure roller/belt 234, 236. As shown in FIG. 6, the length of the pressure roller/belt 234, 236 lies in the cross-process direction, which is perpendicular to the processing direction.

As shown in FIG. 1, the processor 224 controls the heating elements 250, 252, 254 to simultaneously produce different amounts of heat from different ones of the heating elements to heat different portions (along the length) of the pressure roller/belt 234, 236 differently based upon the gloss level of the printed sheets. More specifically, the processor 224 adjusts the heating of the different length portions of the pressure roller/belt 234, 236 differently based upon the thickness and size of the sheets of media and the position of the sheets of media on the pressure roller/belt 234, 236.

In some embodiments, a gloss sensor (item 218, shown in FIG. 5) is operatively connected to the processor 224. The gloss sensor 218 can be placed along the media path in any position that senses a gloss level of the sheets of media before, during, and/or after the sheets of media reach the marking station 210. For example, the gloss sensor 218 can be placed between the sheet supply 214 and the printing engine 210 to detect the gloss level of sheets coming out of the sheets supplied 214; between the imaging stations 324 and the fusing station 336 (shown in FIG. 8, below) or between the inkjets 421 and the spreader 440 (shown in FIG. 9, below) to detect gloss level pre-fusing/pre-spreading; and/or between the printing engines and the machine exit to detect the gloss level of printed sheets. Therefore, the embodiments could include a single gloss sensor, or multiple gloss sensors. In such embodiments, the processor 224 automatically and dynamically adjusts the heating of the different portions of the pressure roller/belt 234, 236 differently based upon the gloss level of the sheets of media detected by the gloss sensor. This allows the gloss level to constantly be adjusted to compensate for machine wear, changing environmental conditions, changing print job requirements, etc.

FIG. 8 illustrates a more specific implementation of the printing device 204 shown in FIG. 5. In FIG. 8, a printing machine 310 is shown that includes an automatic document feeder 320 (ADF) that can be used to scan (at a scanning station 322) original documents 311 fed from a tray 319 to a tray 323. The user may enter the desired printing and finishing instructions through the graphic user interface (GUI) or control panel 317, or use a job ticket, an electronic print job description from a remote source, etc. The control panel 317 can include one or more processors 360, power supplies, as well as storage devices 362 storing programs of instructions that are readable by the processors 360 for performing the various functions described herein. The storage devices 362 can comprise, for example, non-volatile storage mediums including magnetic devices, optical devices, capacitor-based devices, etc.

An electronic or optical image or an image of an original document or set of documents to be reproduced may be projected or scanned onto a charged surface 313 or a photoreceptor belt 318 to form an electrostatic latent image. The belt photoreceptor 318 here is mounted on a set of rollers 326. At least one of the rollers is driven to move the photoreceptor in the direction indicated by arrow 321 past the various other known electrostatic processing stations including a charging station 328, imaging station 324 (for a raster scan laser system 325), developing station 330, and transfer station 332.

Thus, the latent image is developed with developing material to form a toner image corresponding to the latent image. More specifically, a sheet 315 is fed from a selected paper tray supply 333 to a sheet transport 334 for travel to the transfer station 332. There, the toned image is electrostatically transferred to a final print media material 315, to which it may be permanently fixed by a fusing device 316. The sheet is stripped from the photoreceptor 318 and conveyed to a fusing station 336 having fusing device 316 where the toner image is fused to the sheet. A guide can be applied to the substrate 315 to lead it away from the fuser roll. After separating from the fuser roll, the substrate 315 is then transported by a sheet output transport 37 to output trays a multi-function finishing station 350.

Printed sheets 315 from the printer 310 can be accepted at an entry port 338 and directed to multiple paths and output trays 354, 355 for printed sheets, corresponding to different desired actions, such as stapling, hole-punching and C or Z-folding. The finisher 350 can also optionally include, for example, a modular booklet maker 340 although those ordinarily skilled in the art would understand that the finisher 350 could comprise any functional unit, and that the modular booklet maker 340 is merely shown as one example. The finished booklets are collected in a stacker 370. It is to be understood that various rollers and other devices which contact and handle sheets within finisher module 350 are driven by various motors, solenoids and other electromechanical devices (not shown), under a control system, such as including the microprocessor 360 of the control panel 317 or elsewhere, in a manner generally familiar in the art.

Thus, the multi-functional finisher 350 has a top tray 354 and a main tray 355 and a folding and booklet making section 340 that adds stapled and unstapled booklet making, and single sheet C-fold and Z-fold capabilities. The top tray 354 is used as a purge destination, as well as, a destination for the simplest of jobs that require no finishing and no collated stacking. The main tray 355 can have, for example, a pair of pass-through sheet upside down staplers 356 and is used for most jobs that require stacking or stapling.

As would be understood by those ordinarily skilled in the art, the printing device 10 shown in FIG. 8 is only one example and the embodiments herein are equally applicable to other types of printing devices that may include fewer components or more components. For example, while a limited number of printing engines and paper paths are illustrated in FIG. 8, those ordinarily skilled in the art would understand that many more paper paths and additional printing engines could be included within any printing device used with embodiments herein.

FIG. 9 illustrates a more specific implementation of the printing device 204 shown in FIG. 5. FIG. 9 is a side view of a direct-to-sheet, continuous-web, phase-change ink printer. A very long (i.e., substantially continuous) web W of “substrate” (paper, plastic, or other printable material), supplied on a spool 410, is unwound as needed, propelled by a variety of motors, not shown. A set of rolls 412 controls the tension of the unwinding web as the web moves through a path.

Along the path a preheater 418 brings the web to an initial predetermined temperature. The preheater 418 can rely on contact, radiant, conductive, or convective heat to bring the web W to a target preheat temperature, in one practical embodiment, of about 30° C. to about 70° C.

The web W moves through a printing station 420 including a series of printheads 421A, 421B, 421C, and 421D, each printhead effectively extending across the width of the web and being able to place ink of one primary color directly (i.e., without use of an intermediate or offset member) onto the moving web. As is generally familiar, each of the four primary-color images (e.g., cyan, magenta, yellow and black, or other suitable colors) placed on overlapping areas on the web W combine to form a full-color image, based on the image data sent to each printhead through image path 422. In various possible embodiments, there may be provided multiple printheads for each primary color; the printheads can each be formed into a single linear array; the function of each color printhead can be divided among multiple distinct printheads located at different locations along the process direction; or the printheads or portions thereof can be mounted movably in a direction transverse to the process direction P, such as for spot-color applications.

The ink directed to web W in this embodiment is a “phase-change ink,” by which is meant that the ink is substantially solid at room temperature and substantially liquid when initially jetted onto the web W. Currently-common phasechange inks are typically heated to about 100° C. to about 140° C., and thus in liquid phase, upon being jetted onto the web W. Generally speaking, the liquid ink cools down quickly upon hitting the web W.

Associated with each primary color printhead is a backing member 424 A, 424B, 424C, 424D, typically in the form of a bar or roll, which is arranged substantially opposite the printhead on the other side of web W. Each backing member is used to position the web W so that the gap between the printhead and the sheet stays at a known, constant distance. Each backing member can be controlled to cause the adjacent portion of the web to reach a predetermined “ink-receiving” temperature, in one practical embodiment, of about 40° C. to about 60° C. In various possible embodiments, each backing member can include heating elements, cavities for the flow of liquids, etc.; alternatively, the “member” can be in the form of a flow of air or other gas against or near a portion of the web W. The combined actions of preheater 418 plus backing members 424 held to a particular target temperature effectively maintains the web W in the printing zone 420 in a predetermined temperature range of about 45° C. to about 65° C.

As the partially-imaged web moves to receive inks of various colors throughout the printing station 420, it is required that the temperature of the web be maintained to within a given range. Ink is jetted at a temperature typically significantly higher than the receiving web's temperature and thus will heat the surrounding paper (or whatever substance the web W is made of). Therefore, the members in contact with or near the web in zone 420 must be adjusted so the desired web temperature is maintained. For example, although the backing members will have an effect on the web temperature, the air temperature and air flow rate behind and in front of the web will also impact the web temperature and thus must be considered when controlling the web temperature, and thus the web temperature could be affected by utilizing air blowers or fans behind the web in printing station 420.

Thus, the web temperature is kept substantially uniform for the jetting of all inks from printheads in the printing zone 420. This uniformity is valuable for maintaining image quality, and particularly valuable for maintaining constant ink lateral spread (i.e., across the width of web W, such as perpendicular to process direction P) and constant ink penetration of the web. Depending on the thermal properties of the particular inks and the web, this web temperature uniformity may be achieved by preheating the web and using uncontrolled backer members, and/or by controlling the different backer members 424A, 424B, 424C, 424D to different temperatures to keep the substrate temperature substantially constant throughout the printing station. Temperature sensors (not shown) associated with the web W may be used with a control system to achieve this purpose, as well as systems for measuring or inferring (from the image data, for example) how much ink of a given primary color from a printhead is being applied to the web W at a given time. The various backer members can be controlled individually, using input data from the printhead adjacent thereto, as well as from other printheads in the printing station.

Following the printing zone 420 along the web path is a series of tension rolls 426, followed by one or more “midheaters” 430. The midheater 430 can use contact, radiant, conductive, and/or convective heat to bring the web W to the target temperature. The midheater 430 brings the ink placed on the web to a temperature suitable for desired properties when the ink on the web is sent through an ink spreader 440, discussed in greater detail below. In one embodiment, a useful range for a target temperature for the midheater is about 35° C. to about 80° C. The midheater 430 has the effect of equalizing the ink and substrate temperatures to within about 15° C. of each other. Lower ink temperature gives less line spread while higher ink temperature causes show-through (visibility of the image from the other side of the print). The midheater 430 adjusts substrate and ink temperatures to 0° C. to 20° C. above the temperature of the ink spreader, which will be described below.

Following the midheaters 430, along the path of web W, is the ink spreader 440, that applies a predetermined pressure, and in some implementations, heat, to the web W. The function of the ink spreader 440 is to take what are essentially isolated droplets of ink on web W and spread them out to make a continuous layer by pressure, and, in one embodiment, heat, so that spaces between adjacent drops are filled and image solids become uniform. In addition to spreading the ink, the ink spreader 440 may also improve image permanence by increasing ink layer cohesion and/or increasing the ink-web adhesion. The ink spreader 440 includes rolls, such as imageside roll 442 and pressure roll 444, that apply heat and pressure to the web W. Either roll can include heat elements such as 446 to bring the web W to a temperature in a range from about 35° C. to about 80° C.

In one practical embodiment, the roll temperature in the ink spreader 440 is maintained at about 55° C.; generally, a lower roll temperature gives less line spread while a higher temperature causes imperfections in the gloss. A roll temperature higher than about 57° C. causes ink to offset to the roll. In one practical embodiment, the nip pressure is set in a range of about 750 to about 4,000 psi, or from about 800 to about 4,000 psi, or from about 900 to about 4,000 psi, or from about 1,100 to about 4,000 psi, or from about 900 to about 1,200 psi. Lower nip pressure gives less line spread while higher may reduce pressure roll life.

The ink spreader 440 can also include a cleaning/oiling station 448 associated with image-side roll 442, suitable for cleaning and/or applying a layer of some lubricant or other material to the roll surface. Such a station coats the surface of the ink spreader roll with a lubricant such as amino silicone oil having viscosity of about 410-200 centipoises. Other silicone functional and non-functional oils with identical viscosities can also be used for this purpose. Only small amounts of oil are required and the oil carry out by web W is only about 1-20 mg per A4 size page.

In one possible embodiment, the midheater 430 and ink spreader 440 can be combined within a single unit, with their respective functions occurring relative to the same portion of web W simultaneously.

In the ink spreader 440, the image side roll 442 contacting the inked side of the web is typically reasonably hard, such as being made of anodized aluminum. For the pressure roll 444, a relatively softer roll is used, with a durometer anywhere from about 50 D to about 65 D, with elastic modulii from about 65 MPa to about 115 MPa, and may include a thin elastomer overcoat. In various practical applications, elastomeric or rubbery pressure rolls of one or more layers, with effective elastic modulii from about 50 MPa to about 200 MPa, can be provided.

In a practical implementation, detailed and independent control of the respective temperatures associated with ink spreader 440 (by a control system, not shown) enables gloss adjustment given particular operating conditions and desired print attributes.

It will be recognized by those experienced in the art that the temperatures and pressures effective for spreading an ink of a given formulation will depend on the ink's specific thermal properties. Following passage through the ink spreader 440, the printed 420 web can be output, imaged on the other side, cut into pages, such as for binding, etc. represented by item 450. Although printing on a substantially continuous web is shown in the embodiment, the pressure member can be applied to a cut-sheet system as well. Different preheat, midheat and ink spreader temperature setpoints can be selected for different types and weights of web media.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. Nos. 6,032,004, and 7,874,664 the complete disclosures of which are fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the embodiments herein cannot be implied or imported from any above example as limitations to any particular order, number, position, size, shape, angle, color, or material.

What is claimed is:

1. A printer apparatus comprising:
a processor;
a media path operatively connected to said processor, said media path feeding print media within said printer apparatus;
a marking station operatively connected to said processor, said marking station being positioned along said media path, said marking station placing marking material on said print media;
a pressure item positioned along said media path, said pressure item pressing said print media to join said marking material to said print media, said pressure item comprising one of a pressure belt and a pressure roller; and
heating elements operatively connected to said processor,
said heating elements being positioned adjacent said pressure item, and
said processor controlling said heating elements to heat different portions of said pressure item differently based upon a gloss level of said print media.

2. The printer apparatus according to claim 1, said processor adjusting heating of said different portions of said pressure item differently based upon a thickness and size of said print media and a position of said print media on said pressure item.

3. The printer apparatus according to claim 1, further comprising a gloss sensor operatively connected to said processor, said gloss sensor being positioned along said media path in a position that senses a gloss level of said print media one of before and after said print media reach said marking station.

4. The printer apparatus according to claim 3, said processor adjusting heating of said different portions of said pressure item differently based upon said gloss level of said print media detected by said gloss sensor.

5. The printer apparatus according to claim 1, said pressure item having an axle around which said pressure item rotates, said pressure item having a length parallel to said axle, said heating elements being positioned along said length of said pressure item.

6. A printer apparatus comprising:
a processor;
a media path operatively connected to said processor, said media path feeding print media within said printer apparatus; and
a marking station operatively connected to said processor, said marking station being positioned along said media path, said marking station placing marking material on said print media;
a pressure roller positioned along said media path, said pressure roller pressing said print media to join said marking material to said print media; and
independently controlled heating elements operatively connected to said processor,
said heating elements being positioned adjacent said pressure roller, and
said processor controlling said heating elements to simultaneously produce different amounts of heat from different ones of said heating elements to heat different portions of said pressure roller differently based upon a gloss level of said print media.

7. The printer apparatus according to claim 6, said processor adjusting heating of said different portions of said pressure roller differently based upon a thickness and size of said print media and a position of said print media on said pressure roller.

8. The printer apparatus according to claim 6, further comprising a gloss sensor operatively connected to said processor, said gloss sensor being positioned along said media path in a position that senses a gloss level of said print media one of before and after said print media reach said marking station.

9. The printer apparatus according to claim 8, said processor adjusting heating of said different portions of said pressure roller differently based upon said gloss level of said print media detected by said gloss sensor.

10. The printer apparatus according to claim 6, said pressure roller having an axle around which said pressure roller rotates, said pressure roller having a length parallel to said axle, said heating elements being positioned along said length of said pressure roller.

11. A printing method comprising:
feeding print media on a media path within a printer device; and
placing marking material on said print media using a marking station positioned along said media;
pressing said print media using a pressure roller positioned along said media path to join said marking material to said print media; and
controlling heating elements positioned adjacent said pressure roller to heat different portions of said pressure roller differently based upon a gloss level of said print media using a processor of said printer device.

12. The printing method according to claim 11, said controlling of said heating elements comprising adjusting heating of said different portions of said pressure roller differently based upon a thickness and size of said print media and a position of said print media on said pressure roller.

13. The printing method according to claim 11, further comprising sensing a gloss level of said print media one of before and after said print media reach said marking station using a gloss sensor.

14. The printing method according to claim 11, said controlling of said heating elements comprising adjusting heating of said different portions of said pressure roller differently based upon a gloss level of said print media detected by a gloss sensor.

15. The printing method according to claim 11, said pressure roller having an axle around which said pressure roller rotates, said pressure roller having a length parallel to said axle, said heating elements being positioned along said length of said pressure roller.

16. A non-transitory computer storage medium storing instructions readable by a computerized device, said instructions causing said computerized device to perform a method comprising:
feeding print media on a media path within a printer device; and
placing marking material on said print media using a marking station positioned along said media;
pressing said print media using a pressure roller positioned along said media path to join said marking material to said print media; and
controlling heating elements positioned adjacent said pressure roller to heat different portions of said pressure roller differently based upon a gloss level of said print media using a processor of said print media.

17. The non-transitory computer storage medium according to claim 16, said controlling of said heating elements comprising adjusting heating of said different portions of said pressure roller differently based upon a thickness and size of said print media and a position of said print media on said pressure roller.

18. The non-transitory computer storage medium according to claim 16, further comprising sensing a gloss level of said print media one of before and after said print media reach said marking station using a gloss sensor.

19. The non-transitory computer storage medium according to claim 16, said controlling of said heating elements comprising adjusting heating of said different portions of said pressure roller differently based upon a gloss level of said print media detected by a gloss sensor.

20. The non-transitory computer storage medium according to claim 16, said pressure roller having an axle around which said pressure roller rotates, said pressure roller having a length parallel to said axle, said heating elements being positioned along said length of said pressure roller.
